(19) United States
(12) Patent Application Publication
(10) Pub. No.: US 2026/0240262 A1
(43) Pub. Date: Aug. 20, 2026

(54) AEROSOL GENERATION SYSTEM

(71) Applicant: JAPAN TOBACCO INC., Tokyo (JP)

(72) Inventor: Hiroshi TEZUKA, Tokyo (JP)

(73) Assignee: JAPAN TOBACCO INC., Tokyo (JP)

(21) Appl. No.: 19/473,148

(22) PCT Filed: May 23, 2023
(86) PCT No.: PCT/JP2023/019132

§ 371 Date: Oct. 7, 2025

(51) Int. Cl. A24F 40/85; A24F 40/10; A24F 40/42; A24F 40/44; A24F 40/46; A24F 40/53; A24F 40/57; A24F 40/95; H05B 3/06

(52) U.S. Cl. CPC A24F 40/85; A24F 40/10; A24F 40/42; A24F 40/44; A24F 40/46; A24F 40/53; A24F 40/57; A24F 40/95; H05B 3/06

(57) ABSTRACT

An aerosol-generating system includes a housing, a substrate accommodating portion with a first opening for inserting and removing a substrate, and a tubular member having openings at both ends and connected to the substrate accommodating portion. The system also includes a battery accommodating portion with a third opening for inserting and removing a battery pack, a load configured to generate energy for heating an aerosol source in the substrate using power from the battery pack, and a control unit configured to control operation of the load. The first opening is located on a face of the housing in a first direction, while the second and third openings are located on a face of the housing in a second direction opposite to the first direction.

### TECHNICAL FIELD

The present disclosure relates to an aerosol-generating system, a control method, and a program.

### BACKGROUND ART

Inhalation devices that generate substances to be inhaled by a user are in widespread use. For example, an inhalation device employs an aerosol source for generating an aerosol, and a substrate including a flavor source or the like for imparting a flavor component to the generated aerosol, to generate an aerosol to which the flavor component has been imparted. The user can enjoy the flavor by inhaling the aerosol to which the flavor component has been imparted, generated by the inhalation device. The action by which the user inhales the aerosol will also be referred to below as “puffing” or a “puffing action”. Devices classified as inhalation devices that may be cited include those used in place of cigarettes, such as heated tobacco, for example. Note that heated tobacco is an inhalation device of the type which generates an aerosol by heating a solid containing an aerosol source.

In recent years, it has been considered desirable to make the batteries of inhalation devices replaceable for the purposes of consumer protection and reduction of environmental burden. In this regard, PTL 1 below discloses an inhalation device in which the battery can be replaced by removing a cover provided on a side face of the inhalation device.

### CITATION LIST

### Patent Literature

PTL 1: CN 107373765 A

### SUMMARY OF INVENTION

### Technical Problem

However, the technology disclosed in PTL 1 has only recently been developed, and there is still room for improvement in various aspects.

Accordingly, the present disclosure was devised in light of the problems above, and the objective of the present disclosure lies in providing an arrangement capable of further improving the quality of a user experience.

### Solution to Problem

In order to solve the problems above, one aspect of the present disclosure provides an aerosol-generating system comprising: a housing; a substrate accommodating portion which has a first opening and accommodates a substrate in such a way that the substrate can be inserted/removed through the first opening; a tubular member with openings at both ends, which has a second opening and is connected to the substrate accommodating portion; a battery accommodating portion which has a third opening and accommodates a battery pack in such a way that the battery pack can be inserted/removed through the third opening; a load for generating energy for heating an aerosol source contained in the substrate accommodated in the substrate accommodating portion, by using power supplied from the battery pack accommodated in the battery accommodating portion; and a control unit for controlling operation of the load, wherein the first opening is provided on a face of the housing in a first direction, and the second opening and the third opening are provided on a face of the housing in a second direction on the opposite side to the first direction.

The aerosol-generating system may further comprise a cover portion for opening/closing the second opening, and a cover portion for opening/closing the third opening.

The aerosol-generating system may further comprise a locking mechanism for locking the cover portion for opening/closing the second opening in a state of closing the second opening, the locking mechanism may comprise a recess and a hook portion, may lock the cover portion for opening/closing the second opening by means of insertion of the hook into the recess, and may unlock the cover portion for opening/closing the second opening by means of removal of the hook portion from the recess, and the hook portion may be provided on one of the housing and the cover portion for opening/closing the second opening, with the recess being provided on the other.

The aerosol-generating system may further comprise a cover portion for opening/closing the third opening, and the cover portion for opening/closing the third opening may open/close the third opening while also opening/closing the second opening.

The cover portion for opening/closing the third opening may be provided to be detachable from the housing.

The aerosol-generating system may further comprise a locking mechanism for locking the cover portion for opening/closing the third opening in a state of closing the third opening.

The control unit may control operation of the locking mechanism for locking the cover portion for opening/closing the third opening, based on an operating state of the aerosol-generating system.

The aerosol-generating system may further comprise a cover portion for opening/closing the first opening, and the control unit may control operation of the locking mechanism for locking the cover portion for opening/closing the third opening so that unlocking of the cover portion for opening/closing the third opening is prohibited in a state in which the cover portion for opening/closing the first opening has opened the first opening, and the second opening is in a closed state.

The aerosol-generating system may further comprise an opening/closing sensor for detecting whether or not the cover portion for opening/closing the third opening has closed the third opening, and the control unit may control operation of the load based on a detection result from the opening/closing sensor.

The aerosol-generating system may further comprise a liquid leak detector which is formed by a liquid-absorbent material arranged at a position in contact with the battery pack accommodated in the battery accommodating portion, and which undergoes a change in external appearance as a result of absorbing liquid.

The aerosol-generating system may further comprise a charging terminal for receiving power for charging the battery pack, supplied from an external power source, and the charging terminal may be arranged on the first direction side of the battery accommodating portion, at a position offset from the load in a direction from the second opening toward the third opening.

The aerosol-generating system may further comprise the substrate.

### Advantageous Effects of Invention

The present disclosure as described above provides a mechanism capable of further improving the quality of a user experience.

### BRIEF DESCRIPTION OF DRAWINGS

FIG. 1 is a schematic diagram schematically showing a configuration example of an inhalation device.

FIG. 2 is an oblique view showing an example of the external configuration of an inhalation device according to an embodiment of the present disclosure.

FIG. 3 is an oblique view showing an example of the external configuration of the inhalation device according to the same embodiment.

FIG. 4 is an oblique view showing an example of the external configuration of the inhalation device according to the same embodiment.

FIG. 5 is an oblique view showing an example of the external configuration of the inhalation device according to the same embodiment.

FIG. 6 schematically shows an example of the internal configuration of the inhalation device according to the same embodiment.

FIG. 7 schematically shows the internal configuration of the inhalation device according to the same embodiment.

FIG. 8 schematically shows an example of the configuration close to a cleaning hole cover on a bottom face of an inhalation device according to a first variant example.

FIG. 9 schematically shows an example of the configuration close to the cleaning hole cover on the bottom face of the inhalation device according to the same variant example.

FIG. 10 schematically shows an example of the configuration close to the cleaning hole cover on the bottom face of the inhalation device according to the same variant example.

FIG. 11 schematically shows an example of the configuration close to a battery cover on a bottom face of an inhalation device according to a second variant example.

FIG. 12 schematically shows an example of the configuration close to the battery cover on the bottom face of the inhalation device according to the same variant example.

FIG. 13 schematically shows an example of the internal configuration of an inhalation device according to a third variant example.

### DESCRIPTION OF EMBODIMENTS

Preferred embodiments of the present disclosure will be described in detail below with reference to the appended drawings. It should be noted that components having substantially the same functional configuration will be assigned the same reference numbers in the description and drawings to avoid giving a duplicate description.

### 1. Basic Configuration Example

An inhalation device is a device for generating a substance to be inhaled by a user. Hereinafter, the substance generated by the inhalation device will be described as being an aerosol. Alternatively, the substance generated by the inhalation device may be a gas.

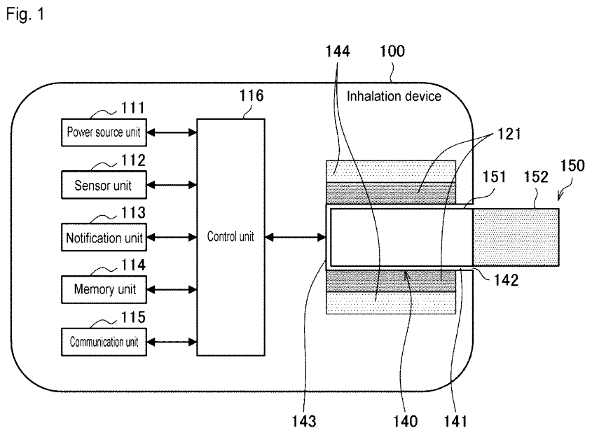

FIG. 1 is a schematic diagram schematically showing a configuration example of an inhalation device. As shown in FIG. 1, an inhalation device 100 according to this configuration example comprises: a power source unit 111, a sensor unit 112, a notification unit 113, a memory unit 114, a communication unit 115, a control unit 116, a heating unit 121, an accommodating portion 140, and a heat insulating portion 144.

The power source unit 111 stores electrical power. The power source unit 111 then supplies the electrical power to each component of the inhalation device 100 in accordance with control performed by the control unit 116. The power source unit 111 may be configured by a rechargeable battery such as a lithium ion secondary battery, for example.

The sensor unit 112 acquires various types of information relating to the inhalation device 100. As an example, the sensor unit 112 is configured by a pressure sensor such as a condenser microphone, a flow rate sensor or a temperature sensor, etc., and acquires values associated with inhalation by a user. As another example, the sensor unit 112 is configured by an input device, such as a button or switch, for accepting input of information from the user.

The notification unit 113 notifies the user of information. The notification unit 113 is configured by a light-emitting device which emits light, a display device which displays images, a sound output device which outputs sound, or a vibration device which vibrates, etc., for example.

The memory unit 114 stores various types of information for operation of the inhalation device 100. The memory unit 114 is configured by a non-volatile storage medium such as a flash memory, for example.

The communication unit 115 is a communication interface capable of performing communication conforming to any wired or wireless communication standard. Examples of communication standards that may be used include standards that employ Wi-Fi (registered trademark), Bluetooth (registered trademark), BLE (Bluetooth Low Energy) (registered trademark), NFC (Near-Field Communication), or LPWA (Low Power Wide Area), for example.

The control unit 116 functions as an arithmetic processing device and a control device, and controls overall operation within the inhalation device 100 in accordance with various programs. The control unit 116 is realized by a CPU (central processing unit) or an electronic circuit such as a microprocessor, for example.

The accommodating portion 140 has an internal space 141, and holds a stick-type substrate 150 while accommodating a portion of the stick-type substrate 150 in the internal space 141. The accommodating portion 140 has an opening 142 allowing the internal space 141 to communicate with the outside, and accommodates the stick-type substrate 150 which has been inserted into the internal space 141 from the opening 142. For example, the accommodating portion 140 is a cylindrical body comprising the opening 142 and a bottom portion 143 serving as a bottom surface, and defines a columnar internal space 141. An air flow path for supplying air to the internal space 141 is connected to the accommodating portion 140. An air inflow hole, which is an inlet for air into the air flow path, is disposed in a side surface of the inhalation device 100, for example. An air outflow hole, which is an outlet for air from the air flow path to the internal space 141, is disposed in the bottom portion 143, for example.

The stick-type substrate 150 comprises a substrate portion 151 and a mouthpiece portion 152. The substrate portion 151 contains an aerosol source. The aerosol source includes a tobacco-derived or non-tobacco-derived flavor component. If the inhalation device 100 is a medical inhaler such as a nebulizer, the aerosol source may include a drug. The aerosol source may, for example, be a liquid such as water or a polyhydric alcohol, for example glycerol or propylene glycol, containing the tobacco-derived or non-tobacco-derived flavor component, or may be a solid including the tobacco-derived or non-tobacco-derived flavor component. In a state in which the stick-type substrate 150 is held in the accommodating portion 140, at least part of the substrate portion 151 is accommodated in the internal space 141, and at least part of the mouthpiece portion 152 protrudes from the opening 142. Then, when the user holds the mouthpiece portion 152 protruding from the opening 142 in their mouth and inhales, air flows into the internal space 141 via the air flow path, which is not illustrated in the drawings, and reaches the inside of the user's mouth together with the aerosol generated from the substrate portion 151.

The heating unit 121 heats the aerosol source to atomize the aerosol source, thereby generating the aerosol. In the example shown in FIG. 1, the heating unit 121 has a film-like form and is arranged so as to cover the outer circumference of the accommodating portion 140. Then, when the heating unit 121 generates heat, the substrate portion 151 of the stick-type substrate 150 is heated from the outer circumference and an aerosol is generated. The heating unit 121 generates heat when supplied with electricity from the power source unit 111. By way of example, electricity may be supplied when the sensor unit 112 detects that the user has started inhaling and/or that predetermined information has been input. The supply of electricity may then be stopped when the sensor unit 112 detects that the user has finished inhaling and/or that predetermined information has been input.

The heat insulating portion 144 prevents heat transfer from the heating unit 121 to other components. For example, the heat insulating portion 144 is configured from a vacuum heat insulating material or an aerogel heat insulating material, or the like.

A configuration example of the inhalation device 100 has been described above. The inhalation device 100 is, of course, not limited to the configuration described above, and may adopt various configurations, such as those illustrated below by way of example.

As one example, the heating unit 121 may have a blade-like form and may be arranged so as to protrude into the internal space 141 from the bottom portion 143 of the accommodating portion 140. In that case, the blade-like heating unit 121 is inserted into the substrate portion 151 of the stick-type substrate 150 and heats the substrate portion 151 of the stick-type substrate 150 from the inside. As another example, the heating unit 121 may be arranged so as to cover the bottom portion 143 of the accommodating portion 140. Furthermore, the heating unit 121 may be configured by a combination of two or more from among a first heating unit covering the outer circumference of the accommodating portion 140, a blade-like second heating unit, and a third heating unit covering the bottom portion 143 of the accommodating portion 140.

As another example, the accommodating portion 140 may comprise an opening/closing mechanism such as a hinge for opening/closing part of a casing that forms the internal space 141. By opening/closing the casing, the accommodating portion 140 may then receive and grip the stick-type substrate 150 that has been inserted into the internal space 141. In that case, the heating unit 121 may be provided on the part of the accommodating portion 140 gripping the stick-type substrate 150, and may heat the stick-type substrate 150 while pressing same.

Furthermore, the means for atomizing the aerosol source is not limited to heating provided by the heating unit 121. For example, the means for atomizing the aerosol source may be induction heating. In that case, the inhalation device 100 comprises at least an electromagnetic induction source such as a coil for generating a magnetic field, instead of the heating unit 121. A susceptor which generates heat by means of induction heating may be provided in the inhalation device 100, or may be contained in the stick-type substrate 150.

### 2. Detailed Configuration Example

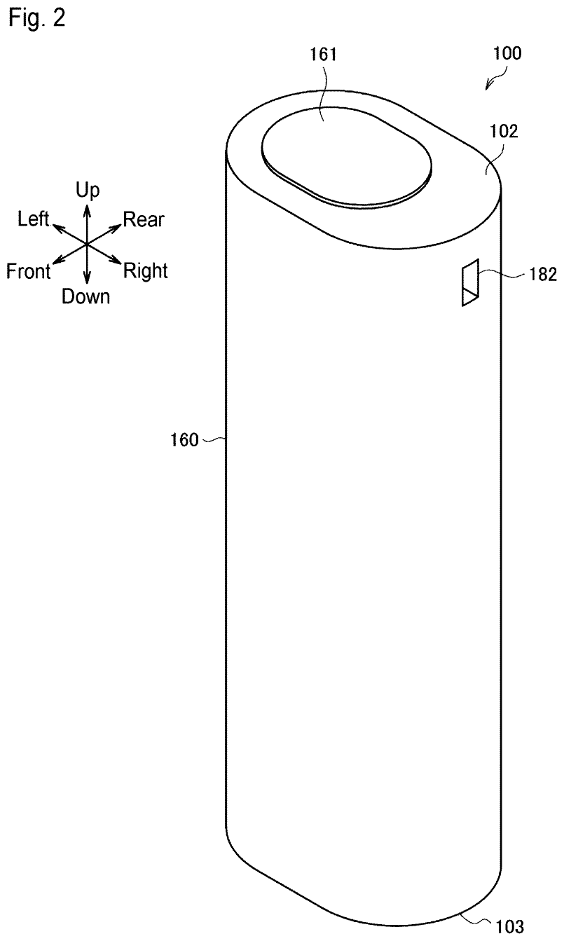

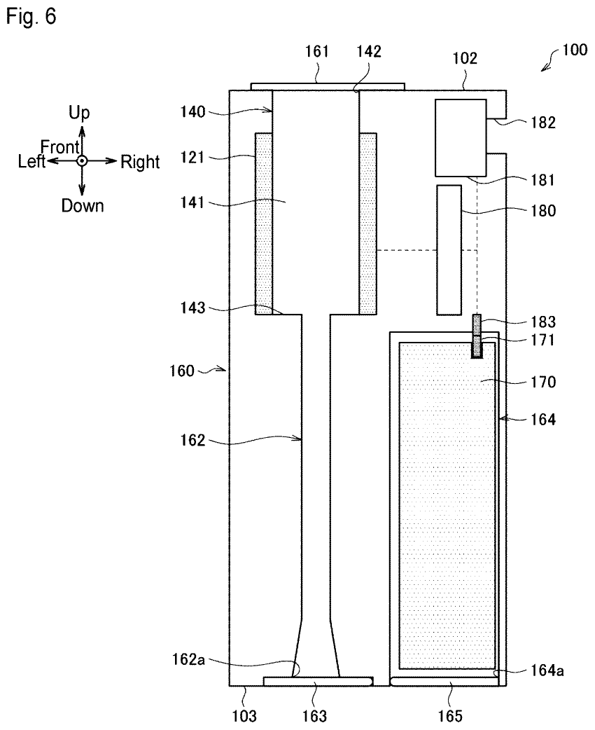

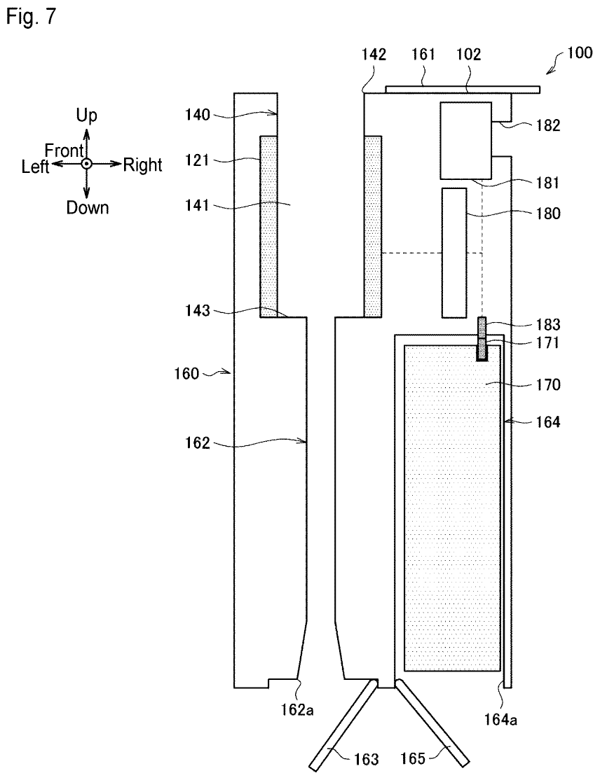

A detailed configuration example of the inhalation device 100 according to an embodiment of the present disclosure will be described with reference to FIG. 2-7. FIG. 2-5 are oblique views showing an example of the external configuration of the inhalation device 100 according to the embodiment. FIGS. 6 and 7 schematically show an example of the internal configuration of the inhalation device 100 according to the embodiment. It should be noted that components shown in FIG. 1 may be omitted from FIG. 2-7. Furthermore, duplicate descriptions of components which were described with reference to FIG. 1 will not be given below.

As shown in FIG. 2-5, the inhalation device 100 may be configured as a straight columnar element with a top face 102 and a bottom face 103 having an oval-shaped cross section. The inhalation device 100 is sized so that it can be gripped by a user, and used while being gripped by the user. It should be noted that a user interface such as a button for inputting operating instructions to the inhalation device 100, and a display for displaying an operating state of the inhalation device 100 may be provided on the surface of the inhalation device 100, although this is not shown in FIG. 2-5.

In this embodiment, a direction of insertion/removal of the stick-type substrate 150 into/from the accommodating portion 140 will also be referred to below as the vertical direction. The vertical direction corresponds to a longitudinal direction of the inhalation device 100. Furthermore, a longitudinal direction in a cross section of the inhalation device 100 will also be referred to as a lateral direction, and a short-side direction in said cross section will also be referred to as a front-rear direction. An upward direction is an example of a first direction. A downward direction is an example of a second direction on the opposite side to the first direction.

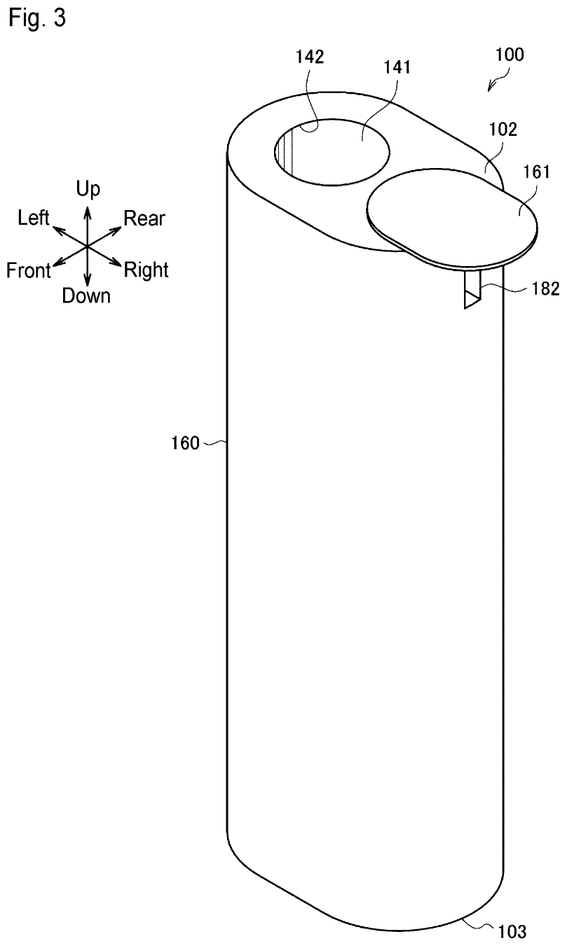

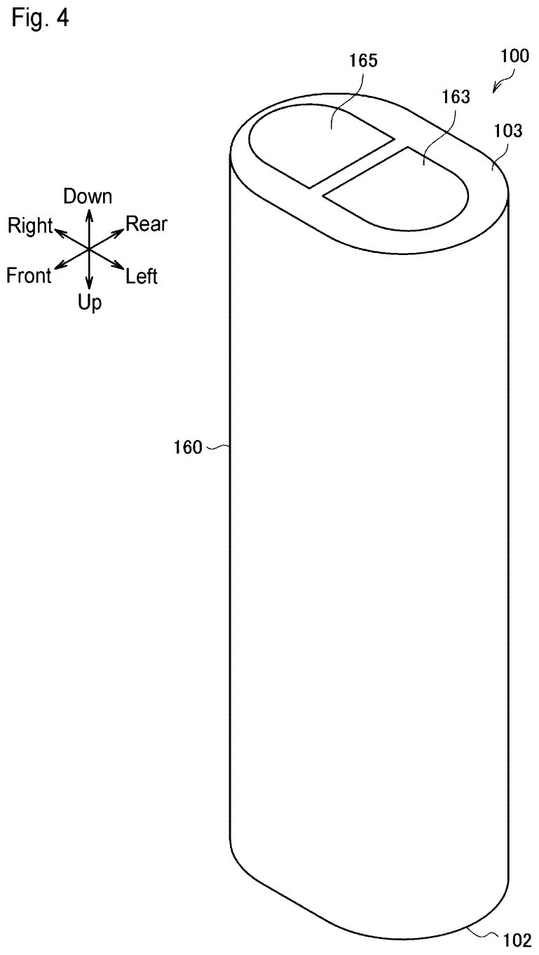

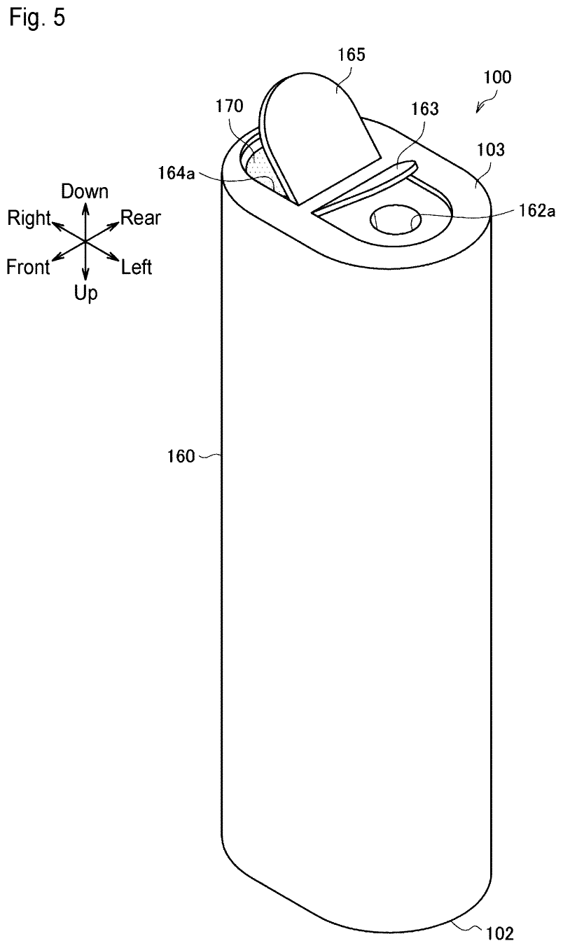

As shown in FIG. 2-7, the inhalation device 100 comprises a housing 160 forming an outermost casing of the inhalation device 100. Components of the inhalation device 100 are then arranged in the housing 160. An opening 142, an opening 162a, and an opening 164a are furthermore provided in the housing 160, and these openings are opened/closed by means of a heater cover 161, a cleaning hole cover 163, and a battery cover 165. These components will be described in detail later. FIG. 2 shows a state in which the heater cover 161 has closed the opening 142. FIG. 3 shows a state in which the heater cover 161 has opened the opening 142. FIG. 4 shows a state in which the cleaning hole cover 163 has closed the opening 162a, and the battery cover 165 has closed the opening 164a. FIG. 5 shows a state in which the cleaning hole cover 163 has opened the opening 162a, and the battery cover 165 has opened the opening 164a. FIG. 6 shows a state in which the heater cover 161 has closed the opening 142, the cleaning hole cover 163 has closed the opening 162a, and the battery cover 165 has closed the opening 164a. FIG. 7 shows a state in which the heater cover 161 has opened the opening 142, the cleaning hole cover 163 has opened the opening 162a, and the battery cover 165 has opened the opening 164a.

The inhalation device 100 comprises the accommodating portion 140, as shown in FIGS. 6 and 7. The accommodating portion 140 is an example of a substrate accommodating portion which has the opening 142 corresponding to a first opening, and accommodates the stick-type substrate 150 in such a way that the stick-type substrate 150 can be inserted/removed through the opening 142. The accommodating portion 140 is a tubular body having the opening 142 on the upper side, with the stick-type substrate 150 being inserted in the downward direction and removed in the upward direction. The accommodating portion 140 will also be referred to below as the “substrate accommodating portion 140”.

As shown in FIGS. 2 and 3, the inhalation device 100 comprises the heater cover 161, which is a cover portion for opening/closing the opening 142 of the substrate accommodating portion 140. The heater cover 161 may be configured as a slider capable of lateral sliding. By opening the heater cover 161, the user can expose the opening 142 to allow insertion of the stick-type substrate 150. Meanwhile, the user can close the heater cover 161 when the stick-type substrate 150 is not inserted, in order to close the opening 142 and prevent debris, such as fragments that have fallen off the stick-type substrate 150, from dropping out from the opening 142.

As shown in FIG. 5-7, the inhalation device 100 comprises a cleaning hole 162. The cleaning hole 162 is a tubular member with openings at both ends, which has the opening 162a corresponding to a second opening, and is connected to the substrate accommodating portion 140. The cleaning hole 162 and the substrate accommodating portion 140 are connected at the bottom portion 143 of the substrate accommodating portion 140 to form a tube with openings at both ends, the opening 142 and the opening 162a constituting the two ends. The user can clean the substrate accommodating portion 140 by inserting a cleaning implement such as a scrubbing brush or a cotton swab into the cleaning hole 162 from the opening 162a, and moving the cleaning implement so that it rubs against the inner wall of the substrate accommodating portion 140. The cleaning hole 162 may be configured with a tapered shape which increases in opening diameter toward the bottom close to the opening 162a. This configuration allows the cleaning implement to be easily inserted into the cleaning hole 162.

As shown in FIG. 4-7, the inhalation device 100 comprises the cleaning hole cover 163 for opening/closing the opening 162a of the cleaning hole 162. The cleaning hole cover 163 may open/close the opening 162a of the cleaning hole 162 by means of a hinge mechanism. By opening the cleaning cover 163 at the time of cleaning, the user can expose the opening 162a to allow cleaning. Meanwhile, the user can close the cleaning hole cover 163 when cleaning is not being performed, in order to close the opening 162a and prevent debris, such as fragments that have fallen off the stick-type substrate 150, from dropping out from the opening 162a.

As shown in FIG. 5-7, the inhalation device 100 comprises a battery accommodating portion 164. The battery accommodating portion 164 has the opening 164a corresponding to a third opening, and accommodates a battery pack 170 in such a way that the battery pack 170 can be inserted/removed through the opening 164a. The battery accommodating portion 164 is a tubular body having the opening 164a on the lower side, with the battery pack 170 being inserted in the upward direction and removed in the downward direction. The diameter of the opening 164a of the battery accommodating portion 164 is typically larger than the diameter of the opening 162a of the cleaning hole 162. This is because the battery pack 170 is often larger than a cleaning implement. Configuring the inhalation device 100 with a removable battery pack 170 allows the user to use the inhalation device 100 for longer while replacing/repairing the battery pack 170. This protects the consumer and protects the environment as a result.

The battery accommodating portion 164 should be formed with a shape that circumscribes the battery pack 170. As an example, the battery pack 170 is preferably configured with a shape that is not easy to rotate about the vertical direction when accommodated in the battery accommodating portion 164, such as an elliptical cylinder shape or a prism shape. By virtue of this configuration, rotation of the battery pack 170 inside the battery accommodating portion 164 is restricted so that a connection between a battery terminal 183 and an electrode 171 (to be described later) can be easily maintained.

As shown in FIG. 5-7, the inhalation device 100 comprises the battery cover 165 for opening/closing the opening 164a. The battery cover 165 may open/close the opening 164a of the battery accommodating portion 164 by means of a hinge mechanism. By opening the battery cover 165 when the battery pack 170 is to be replaced, the user can expose the opening 164a to enable replacement of the battery pack 170. Meanwhile, by closing the battery cover 165 when the battery pack 170 is not being replaced, the user can conceal the battery pack 170 to prevent the battery pack 170 from dropping out, while also preventing contact with the battery pack 170.

The battery pack 170 is a rechargeable battery configured to be removable from the inhalation device 100. A portion of the inhalation device 100 excluding the battery pack 170 will also be referred to as a main body. The battery pack 170 supplies power for operation to each component in the main body of the inhalation device 100. As shown in FIGS. 6 and 7, the battery pack 170 comprises an electrode 171. The electrode 171 constitutes a power interface between the battery pack 170 and the main body of the inhalation device 100. The battery pack 170 inputs or outputs power via the electrode 171. The battery pack 170 may have two electrodes as the electrode 171, namely a positive electrode and a negative electrode, although these are not shown in FIG. 6 or 7.

The inhalation device 100 comprises the battery terminal 183 which is disposed on the battery accommodating portion 164. The battery terminal 183 constitutes a power interface between the main body of the inhalation device 100 and the battery pack 170. The main body of the inhalation device 100 inputs or outputs power via the battery terminal 183. The battery terminal 183 is connected via wiring shown by the broken lines to the heating unit 121, a control circuit 180, and a charging circuit 181, and sends/receives power therebetween. FIGS. 6 and 7 do not show electrical connections with other components. The main body of the inhalation device 100 may have two terminals as the battery terminal 183, namely a positive electrode and a negative electrode, although these are not shown in FIG. 6 or 7.

The battery terminal 183 and the electrode 171 are connected in a state in which the battery pack 170 is accommodated in the battery accommodating portion 164, as shown in FIGS. 6 and 7. This allows power to be sent/received between the main body of the inhalation device 100 and the battery pack 170.

Here, the opening 142 of the substrate accommodating portion 140 is provided on the top face 102, which is a face of the housing 160 in the upward direction. Meanwhile, the opening 162a of the cleaning hole 162 is provided at a position on the bottom face 103, which is a face of the housing 160 in the downward direction, overlapping the opening 142 of the substrate accommodating portion 140 in the front-rear and lateral directions. This configuration enables the substrate accommodating portion 140 and the cleaning hole 162 to be formed as a single linear through-hole, which therefore allows for easy and effective cleaning by inserting a cleaning implement into the cleaning hole 162. Furthermore, the opening 164a of the battery accommodating portion 164 is provided on the same face as for the opening 162a of the cleaning hole 162, i.e., on the bottom face 103 which is a face in the downward direction of the housing 160. This configuration makes it possible to simplify the mechanical structure of the inhalation device 100, therefore allowing the inhalation device 100 to be made more compact. Furthermore, better usability can be achieved by a standardized maintenance method in which it is sufficient to operate the bottom face 103 of the inhalation device 100 for maintenance such as cleaning or replacing the battery pack 170.

The inhalation device 100 comprises the control circuit 180, as shown in FIGS. 6 and 7. The control circuit 180 corresponds to the control unit 116 shown in FIG. 1. The control circuit 180 controls overall processing within the inhalation device 100.

As an example, the control circuit 180 controls operation of the heating unit 121. Operation of the heating unit 121 is controlled by controlling power supply from the battery pack 170 to the heating unit 121. In particular, the control circuit 180 may control power supply from the battery pack 170 to the heating unit 121 on the basis of a heating profile. The heating profile is control information for controlling the temperature at which the aerosol source is heated, and is information indicating a time-series transition of a target value of a parameter corresponding to the temperature of the heating unit 121, for example. The control unit 180 controls power supply to the heating unit 121 so that the parameter corresponding to the temperature of the heating unit 121 transitions to the target temperature in the manner defined in the heating profile. The heating profile is typically designed such that, when the user inhales the aerosol generated from the stick-type substrate 150, the flavor tasted by the user is optimized. The flavor tasted by the user can therefore be optimized by controlling operation of the heating unit 121 based on the heating profile.

The parameter corresponding to the temperature of the heating unit 121 may be an electrical resistance value with the heating unit 121. The temperature of the heating unit 121 can be measured on the basis of the electrical resistance value of the heating unit 121 (a heating resistive element constituting the heating unit 121, to be more precise), for example. This is because the electrical resistance value of the heating resistive element varies with temperature. The electrical resistance value of the heating resistive element can be estimated by measuring the amount of voltage drop at the heating resistive element, for example. The temperature of the heating unit 121 itself may also be an example of a parameter corresponding to the temperature of the heating unit 121. As well as the temperature of the heating unit 121 being measured on the basis of the electrical resistance value of the heating unit 121, the temperature can also be measured by means of a temperature sensor such as a thermistor installed near the heating unit 121.

The temperature control of the heating unit 121 can be realized by known feedback control, for example. The feedback control may be, for example, PID control (Proportional-Integral-Differential Controller). The control unit 116 may cause power from the battery pack 170 to be supplied to the heating unit 121 in the form of pulses by pulse width modulation (PWM) or pulse frequency modulation (PFM). In that case, the control unit 116 can control the temperature of the heating unit 121 by adjusting the duty ratio of the power pulses in the feedback control.

The inhalation device 100 comprises the charging circuit 181, as shown in FIGS. 6 and 7. The charging circuit 181 corresponds to the control unit 116 shown in FIG. 1. The charging circuit 181 controls charging of the battery pack 170 based on control performed by the control circuit 180. The charging circuit 181 supplies the battery pack 170 with power supplied from an external power source via a charging terminal 182. Here, the charging circuit 181 controls the voltage and current of the power supplied to the battery pack 170.

The inhalation device 100 comprises the charging terminal 182, as shown in FIGS. 2, 3, 6 and 7. The charging terminal 182 is an interface between the charging circuit 181 and the external power source for supplying power for charging the battery pack 170 accommodated in the battery accommodating portion 164. The charging terminal 182 then receives power for charging the battery pack 170, supplied from the external power source. As an example, the charging terminal 182 is a USB (universal serial bus) port. A USB cable may then be connected to the charging terminal 182, and power may be supplied to the charging terminal 182 from an outlet via the USB cable.

The charging terminal 182 is arranged on an upper side of a right-hand face of the inhalation device 100. The charging terminal 182 is thus preferably arranged on the upper side of the battery accommodating portion 164, at a position offset from the heating unit 121 toward the right, which is a direction from the opening 162a of the cleaning hole 162 toward the opening 164a of the battery accommodating portion 164. An offset position as referred to here indicates a spaced-apart position or a non-overlapping position. As long as this positional relationship is satisfied, the charging terminal 182 may be arranged at a position other than that shown in FIGS. 6 and 7, and it may be arranged on the top face 102 of the inhalation device 100, or may be arranged on the front face or rear face of the inhalation device 100. By virtue of this configuration, it is possible to limit heat transfer from the heating unit 121 to the charging terminal 182. As a result, it is possible to prevent damage to the charging terminal 182 associated with a temperature increase of the charging terminal 182. Furthermore, this configuration makes it possible to shorten a wiring distance from the charging terminal 182 to the battery pack 170, therefore restricting power losses in the wiring and enabling the battery pack 170 to be charged more efficiently.

### 3. Supplementary Information

A preferred embodiment of the present disclosure has been described in detail above with reference to the appended drawings, but the present disclosure is not limited to such an example. It is obvious that a person having ordinary knowledge in the technical field to which the present disclosure belongs will be able to conceive of a number of variant examples or modified examples within the scope of the technical concept disclosed in the claims, and any such variant examples or modified examples are naturally understood to fall within the technical scope of the present disclosure.

It should be noted that the description below of variant examples will focus on differences with the embodiment above, and features which are the same as those of the embodiment above will not be described again.

### (1) First Variant Example

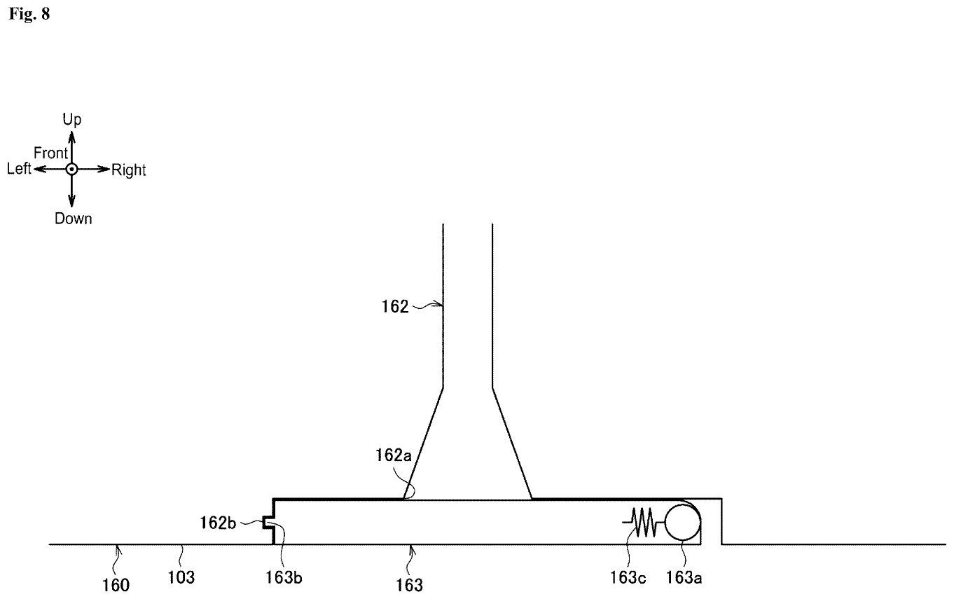

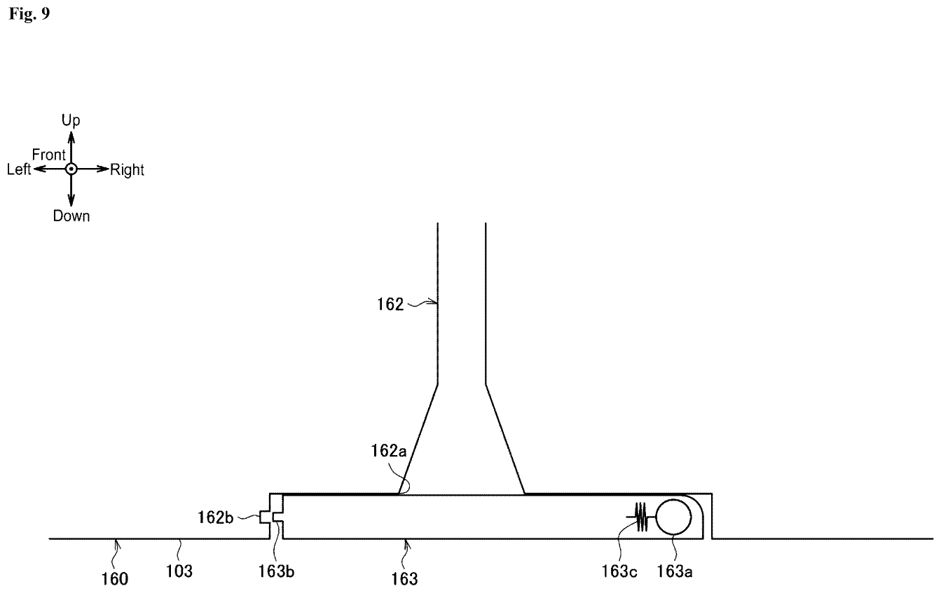

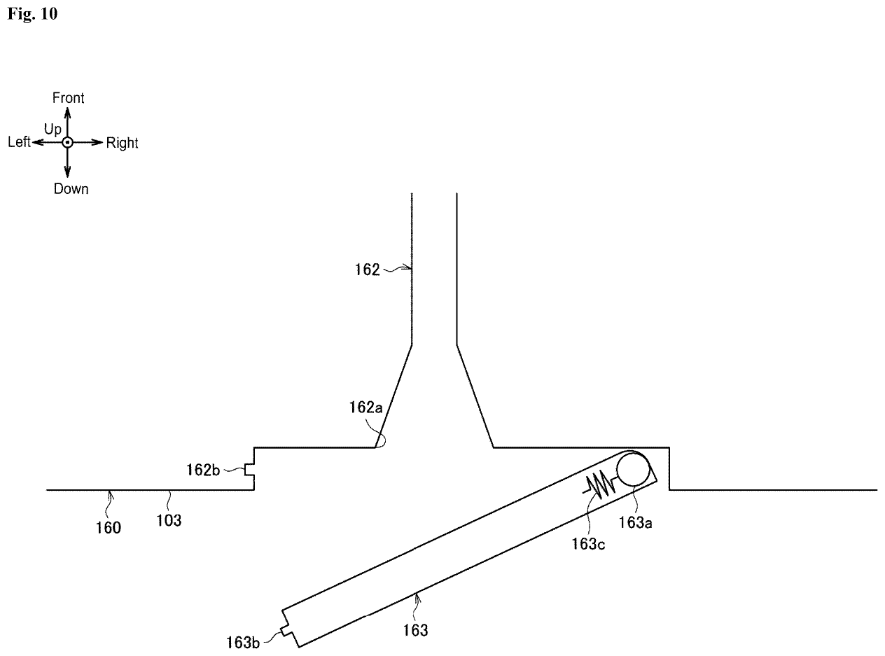

FIG. 8-10 schematically show an example of the configuration close to the cleaning hole cover 163 on the bottom face 103 of the inhalation device 100 according to a first variant example. FIG. 8 shows a state in which the cleaning hole cover 163 is latched to the housing 160 while closing the opening 162a of the cleaning hole 162. FIG. 9 shows a state in which the cleaning hole cover 163 has been unlatched from the housing 160 while still closing the opening 162a of the cleaning hole 162. FIG. 10 shows a state in which the cleaning hole cover 163 has opened the opening 162a of the cleaning hole 162.

As shown in FIG. 8-10, the cleaning hole cover 163 comprises a rotary shaft 163a which is rotatably mounted to the right of an edge of the opening 162a of the cleaning hole 162, on the inside of a right-hand end portion of the cleaning hole cover 163. The cleaning hole cover 163 is therefore rotatable about the rotary shaft 163a. The rotary shaft 163a is part of a hinge mechanism for opening/closing the cleaning hole cover 163. A projecting hook portion 163b is provided at an end portion of the cleaning hole cover 163 on the side remote from the rotary shaft 163a, i.e., at the left-hand end portion. Meanwhile, a recess 162b allowing insertion of the hook portion 163b is provided at a position on the housing 160 corresponding to the hook portion 163b of the cleaning hole cover 163, close to the opening 162a of the cleaning hole 162.

As shown in FIG. 8-10, the cleaning hole cover 163 and the rotary shaft 163a are connected by way of a spring 163c. The spring 163c is then arranged so as to extend and contract in a direction that increases and reduces a distance between the hook portion 163b and the rotary shaft 163a. Extension and contraction of the spring 163c causes insertion of the hook portion 163b into the recess 162b, which is shown in FIG. 8, and withdrawal of the hook portion 163b from the recess 162b, which is shown in FIG. 9.

As shown in FIG. 8, the hook portion 163b is inserted in the recess 162b in a state in which the cleaning hole cover 163 has closed the opening 162a of the cleaning hole 162. The state of insertion of the hook portion 163b in the recess 162b is then maintained by an elastic force acting in a direction of extension of the spring 163c. As a result, it is possible to lock the cleaning hole cover 163 in a state of closing the opening 162a of the cleaning hole 162 while being latched to the housing 160. Meanwhile, as shown in FIG. 9, the hook portion 163b can be withdrawn from the recess 162b to unlock the cleaning hole cover 163 by applying a force to the cleaning hole cover 163 in the direction of contraction of the spring 163c. The cleaning hole 162 can be made rotatable as a result, as shown in FIG. 10.

As described above, the inhalation device 100 may comprise a locking mechanism for locking the cleaning hole cover 163, which opens/closes the opening 162a of the cleaning hole 162, in a state of closing the opening 162a. The rotary shaft 163a, the hook portion 163b, the spring 163c, and the recess 162b shown in FIG. 8-10 are an example of the locking mechanism. The locking mechanism is, of course, not limited to the example shown in FIG. 8-10. For example, the housing 160 may comprise the hook portion 163b instead of the recess 162b, and the cleaning hole cover 163 may comprise the recess 162b instead of the hook portion 163b.

Furthermore, the inhalation device 100 may also comprise a locking mechanism for the heater cover 161 and/or a locking mechanism for the battery cover 165, instead of or as well as the locking mechanism for the cleaning hole cover 163. That is to say, the inhalation device 100 may comprise a locking mechanism for locking the heater cover 161 in a state of closing the opening 142 of the substrate accommodating portion 140. Furthermore, the inhalation device 100 may comprise a locking mechanism for locking the battery cover 165 in a state of closing the opening 164a of the battery accommodating portion 164.

### (2) Second Variant Example

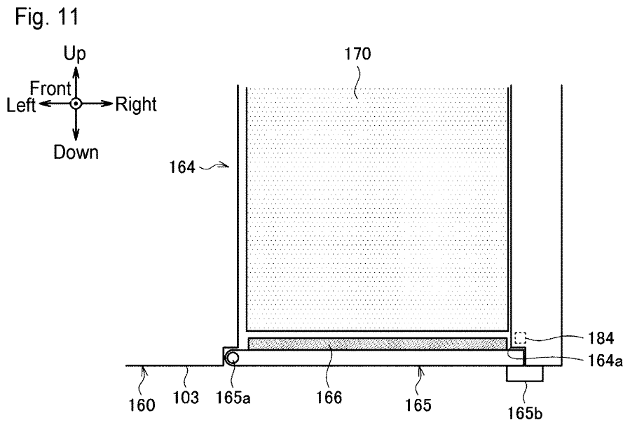

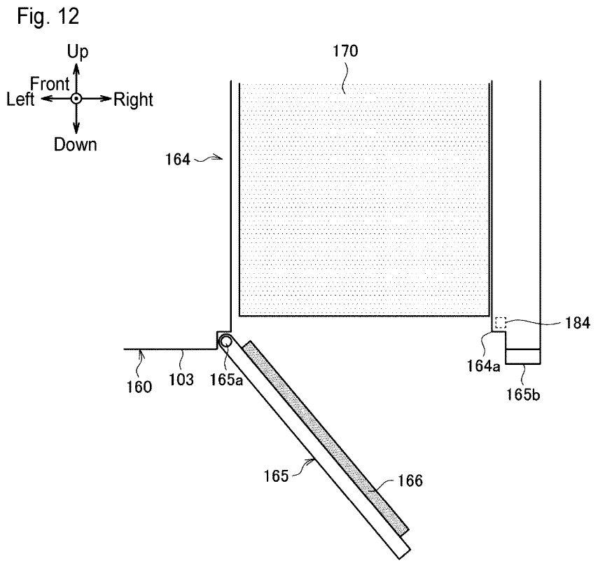

FIGS. 11 and 12 schematically show an example of the configuration close to the battery cover 165 on the bottom face 103 of the inhalation device 100 according to a second variant example. FIG. 11 shows a state in which the battery cover 165 is latched to the housing 160 while closing the opening 164a of the battery accommodating portion 164. FIG. 12 shows a state in which the battery cover 165 has opened the opening 164a of the battery accommodating portion 164.

As shown in FIGS. 11 and 12, the battery cover 165 comprises a rotary shaft 165a which is rotatably mounted to the left of an edge of the opening 164a of the battery accommodating portion 164, on the inside of the left-hand end portion of the battery cover 165. The battery cover 165 is therefore rotatable about the rotary shaft 165a. The rotary shaft 165a is part of a hinge mechanism for opening/closing the battery cover 165. The inhalation device 100 comprises a laterally-slidable retainer 165b to the right of the edge of the opening 164a of the battery accommodating portion 164. As shown in FIG. 11, moving the retainer 165b to the left in a state in which the battery cover 165 has closed the opening 164a of the battery accommodating portion 164 enables the battery cover 165 to be locked in a state of being latched to the housing 160. On the other hand, as shown in FIG. 12, moving the retainer to the right unlocks the battery cover 165 so that the battery cover 165 can be made rotatable.

It should be noted that the retainer 165b is an example of a locking mechanism for locking a state of closure of the opening 164a of the battery accommodating portion 164. The locking mechanism is, of course, not limited to the example shown in FIGS. 11 and 12. As an example, the retainer 165b may be rotatably constructed, and the battery cover 165 may be locked and unlocked depending on an angle of rotation. As another example, the locking mechanism for the battery cover 165 may be configured in the same way as the locking mechanism for the cleaning hole cover 163 illustrated in the first variant example.

The control circuit 180 may control operation of the retainer 165 based on an operating state of the inhalation device 100. As an example, the control circuit 180 may prohibit unlocking by the retainer 165b during heating by the heating unit 121 or during charging of the battery pack 170. Meanwhile, the control circuit 180 may permit unlocking by the retainer 165b only in a period in which neither heating by the heating unit 121 nor charging of the battery pack 170 is being performed. Unlocking by the retainer 165b is prohibited and permitted by fixing the retainer 165b or allowing movement thereof. The battery pack 170 can reach a high temperature during heating by the heating unit 121 and during charging of the battery pack 170. In this regard, the configuration above can improve safety by preventing the user from touching the high-temperature battery pack 170. Alternatively, the control circuit 180 may control operation of the retainer 165b based on an instruction from a user terminal such as a smartphone which is wirelessly connected to the inhalation device 100 by means of Bluetooth or the like.

The inhalation device 100 comprises an opening/closing sensor 184, as shown in FIGS. 11 and 12. The opening/closing sensor 184 detects opening/closing of the opening 164a of the battery accommodating portion 164 by the battery cover 165. For example, the opening/closing sensor 184 may be configured as a proximity sensor of the magnetic detection type, such as a Hall sensor, which may detect opening/closing of the battery cover 165 according to whether or not magnetism corresponding to the battery cover 165 is detected. Alternatively, the opening/closing sensor 184 may detect opening/closing of the battery cover 165 according to whether or not an electrical current passes, or whether or not light is detected, etc. Furthermore, the inhalation device 100 may be provided with a physical button which is depressed when the battery cover 165 is closed, and opening/closing of the battery cover 165 may be detected according to the state of pressing of this physical button.

The control circuit 180 may also control operation of the heating unit 121 based on the detection result from the opening/closing sensor 184. For example, the control unit 180 may permit heating by the heating unit 121 only in a state in which the battery cover 165 is closed. This configuration can improve safety because it can ensure that the user does not directly touch the battery pack 170 which has become hotter along with heating provided by the heating unit 121.

The charging circuit 181 may also control charging of the battery pack 170 based on the detection result from the opening/closing sensor 184. For example, the charging circuit 181 may permit charging of the battery pack 170 only in a state in which the battery cover 165 is closed. This configuration can improve safety because it can ensure that the user does not directly touch the battery pack 170 which has become hotter along with charging.

The inhalation device 100 comprises a liquid leak detector 166, as shown in FIGS. 11 and 12. The liquid leak detector 160 is a member which is formed by a liquid-absorbent material and undergoes a change in external appearance as a result of absorbing liquid. Liquid-absorbent materials which may be used include paper, cloth, nonwoven fabric, a porous resin sheet, or a coated film, etc., or combinations thereof. The change in external appearance may be a change in color, a change in shape, swelling, or formation of irregularities, etc., or combinations thereof. As an example, the liquid leak detector 166 may be formed by printing a liquid-absorbent soluble ink in a predetermined print pattern on a liquid-absorbent sheet formed by a highly absorbent substance such as an absorbent polymer. A liquid-absorbent soluble ink is an ink which can be printed in the same way as a normal ink, but which dissolves when it absorbs liquid after printing, producing a change in color, bleeding, loss of external shape, or penetration and diffusion into the liquid-absorbent sheet, etc. The liquid leak detector 166 is then arranged at a position in contact with the battery pack 170 accommodated in the battery accommodating portion 164. Specifically, as shown in FIGS. 11 and 12, the liquid leak detector 166 may be arranged on a rear side of the battery cover 165. In that case, the user can easily see the liquid leak detector 166 by opening the battery cover 165. As another example, the liquid leak detector 166 may be arranged on an inner wall of the battery accommodating portion 164. As yet another example, the liquid leak detector 166 may be arranged on the surface of the battery pack 170. By virtue of this configuration, even if an electrolyte leaks out from the battery pack 170 due to factors such as deterioration over time, the electrolyte can be absorbed by means of the liquid leak detector 166 in order to prevent leakage to outside of the inhalation device 100. Additionally, the change in external appearance of the liquid leak detector 166 allows the user to easily see whether or not a liquid has leaked from the battery pack 170, enabling the battery pack 170 to be safely replaced.

It should be noted that this variant example describes the example of providing the opening/closing sensor 184 for detecting opening/closing of the battery cover 165, but the present disclosure is not limited to this example. An opening/closing sensor for detecting opening/closing of the heater cover 161 and/or the cleaning hole cover 163 may be equally be provided, instead of or as well as the opening/closing sensor 184 for detecting opening/closing of the battery cover 165.

Based on the state of opening/closing of some or any of the heater cover 161, the cleaning hole cover 163, and the battery cover 165, the control circuit 180 may permit or prohibit unlocking of the other(s).

As an example, the control circuit 180 may control operation of the retainer 165b so that unlocking of the battery cover 165 is prohibited in a state in which the heater cover 161 has opened the opening 142 of the substrate accommodating portion 140, and the cleaning hole cover 163 has closed the opening 162a of the cleaning hole 162. Put more simply, in a state in which the heater cover 161 is open while the cleaning hole cover 163 is closed, the control circuit 180 may fix the retainer 165b in a state in which the battery cover 165 is locked. The stick-type substrate 150 can be inserted into the substrate accommodating portion 140 and heating can be performed by the heating unit 121 in a state in which the heater cover 161 is open while the cleaning hole cover 163 is closed. In this regard, the configuration above can improve safety because it can ensure that the user does not directly touch the battery pack 170 which has become hotter along with heating provided by the heating unit 121.

As another example, the control circuit 180 may control operation of the retainer 165b so that unlocking of the battery cover 165 is permitted in a state in which the heater cover 161 has opened the opening 142 of the substrate accommodating portion 140, and the cleaning hole cover 163 has opened the opening 162a of the cleaning hole 162. Put more simply, in a state in which the heater cover 161 and the cleaning hole cover 163 are both open, the control circuit 180 may permit unlocking of the battery cover 165 by making the retainer 165b movable. Cleaning can be performed using a cleaning implement in a state in which the heater cover 161 and the cleaning hole cover 163 are both open. In this regard, the configuration above can improve ease of maintenance because cleaning and replacement of the battery pack 170 can be carried out at the same time.

### (3) Third Variant Example

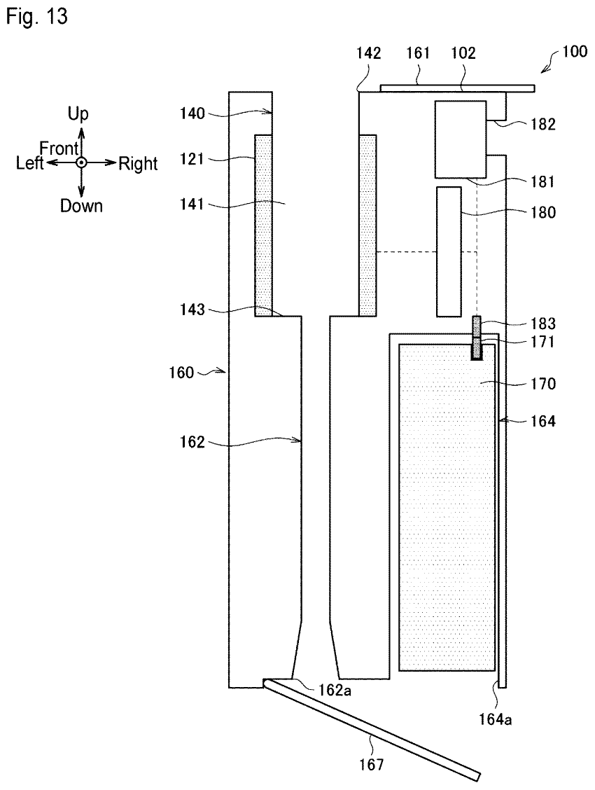

FIG. 13 schematically shows an example of the internal configuration of the inhalation device 100 according to a third variant example. Instead of the cleaning hole cover 163 and the battery cover 165, the inhalation device 100 may comprise a bottom face cover 167 for opening/closing the opening 162a of the cleaning hole 162 and the opening 164a of the battery accommodating portion 164, as shown in FIG. 13. The bottom face cover 167 opens/closes the opening 164a of the battery accommodating portion 164 while also opening/closing the opening 162a of the cleaning hole 162. By opening the bottom face cover 167, the user can therefore open/close the opening 162a of the cleaning hole 162 and the opening 164a of the battery accommodating portion 164 both together. This configuration can provide better usability than when the cleaning hole cover 163 and the battery cover 165 are formed separately, as in the embodiment above.

In this variant example, the inhalation device 100 may further comprise a locking mechanism for locking the bottom face cover 167. Furthermore, the inhalation device 100 may further comprise an opening/closing sensor for detecting opening/closing of the bottom face cover 167. Control of components such as the heating unit 121 based on opening/closing of the bottom face cover 167, and permission and prohibition in regard to unlocking of the bottom face cover 167 may be performed in the same way as in the variant examples described above.

Moreover, the bottom face cover 167 may selectively open only either one of the opening 162a of the cleaning hole 162 and the opening 164a of the battery accommodating portion 164. For example, the bottom face cover 167 may be configured as a slider capable of sliding laterally on the bottom face 103 of the inhalation device 100. In that case, the bottom face cover 167 is positioned in the center in the lateral direction in order to close the opening 162a and the opening 164a, and is moved fully to the right or the left in order to open both the opening 162a and the opening 164a. The bottom face cover 167 is then moved halfway to the right in order to open the opening 162a, and is moved halfway to the left in order to open the opening 164a. In this case, the abovementioned locking mechanism may limit the range over which the bottom face cover 167 is capable of sliding, so as to maintain a closed state of the opening 162a of the cleaning hole 162 and/or the opening 164a of the battery accommodating portion 164. Furthermore, the abovementioned opening/closing sensor may detect opening/closing of each of the opening 162a of the cleaning hole 162 and the opening 164a of the battery accommodating portion 164, based on the position of sliding of the bottom face cover 167.

### (4) Other

The inhalation device 100 is an example of an aerosol-generating system which generates an aerosol by heating an aerosol source. As described above, the battery pack 170 is configured to be removable from the inhalation device 100. The main body of the inhalation device 100 excluding the battery pack 170 may be considered to be an aerosol-generating system, and the whole of the inhalation device 100 including the battery pack 170 may also be considered to be an aerosol-generating system. Furthermore, the combination of the inhalation device 100 and the stick-type substrate 150 may also be considered to be an aerosol-generating system.

The heating unit 121 described above is an example of a load for generating energy for heating the aerosol source contained in the stick-type substrate 150 accommodated in the substrate accommodating portion 140, by using power supplied from the battery pack 170 accommodated in the battery accommodating portion 164. The load may be a heating unit 121 of the resistive heating type, which generates heat by means of resistance, as described above. Alternatively, when the inhalation device 100 heats the aerosol source by means of induction heating, the electromagnetic induction source such as an induction coil corresponds to the load.

The embodiment above described an example in which the diameter of the opening 164a of the battery accommodating portion 164 is larger than the diameter of the opening 162a of the cleaning hole 162, but the present disclosure is not limited to this example. The diameter of the opening 164a of the battery accommodating portion 164 may be the same as the diameter of the opening 162a of the cleaning hole 162, or smaller than the diameter of the opening 162a of the cleaning hole 162.

The mechanism by which the heater cover 161 opens/closes the opening 142 of the substrate accommodating portion 140 is not limited to a slider. As an example, the heater cover 161 may open/close the opening 142 by means of a hinge mechanism. As another example, the heater cover 161 may be configured to be detachable from the housing 160. Similarly, the mechanism by which the cleaning hole cover 163 opens/closes the opening 162a of the cleaning hole 162 is not limited to a hinge mechanism. As an example, the cleaning hole cover 163 may be configured as a slider. As another example, the cleaning hole cover 163 may be configured to be detachable from the housing 160. Similarly, the mechanism by which the battery cover 165 opens/closes the opening 164a of the battery accommodating portion 164 is not limited to a hinge mechanism. As an example, the battery cover 165 may be configured as a slider. As another example, the battery cover 165 may be configured to be detachable from the housing 160. The same also applies to the bottom face cover 167.

The inhalation device 100 may have a further configuration for preventing the battery pack 170 from dropping out from the battery accommodating portion 164. As an example, the opening 164a of the battery accommodating portion 164 may be sealed by an inner cover formed by an elastic body such as rubber. As another example, a screw thread may be provided on a side face of the battery pack 170, and a thread groove may be provided on an inner wall of the battery accommodating portion 164 so that the battery pack 170 can be screwed into the battery accommodating portion 164.

It should be noted that the series of processes performed by each device described in the present description may be realized by using software, hardware, or any combination of software and hardware. Programs constituting the software are prestored on a recording medium (more specifically, a non-transitory computer-readable storage medium) provided internally or externally to each device, for example. When the programs are then executed, for example, by a computer for controlling each device described in the present description, the programs are read into a random access memory (RAM) and executed by means of a processing circuit such as a central processing unit (CPU). The recording medium is, for example, a magnetic disk, an optical disk, a magneto-optical disk, or a flash memory, etc. Furthermore, the computer programs may be distributed via a network, for example, without the use of a recording medium. Furthermore, the computer may be an application-specific integrated circuit (ASIC), a general-purpose processor which executes functions by reading software programs, or a computer on a server used for cloud computing, etc. Furthermore, the series of processes performed by each device described in the present description may be processed centrally by a single computer, or may be processed in a distributed manner by multiple computers. In addition, in the embodiments described above, two or more communication means present in a single device may be physically realized by a single medium.

The following configurations also fall within the technical scope of the present disclosure.
(1)

An aerosol-generating system comprising: a housing;

a substrate accommodating portion which has a first opening and accommodates a substrate in such a way that the substrate can be inserted/removed through the first opening;

a tubular member with openings at both ends, which has a second opening and is connected to the substrate accommodating portion;

a battery accommodating portion which has a third opening and accommodates a battery pack in such a way that the battery pack can be inserted/removed through the third opening;

a load for generating energy for heating an aerosol source contained in the substrate accommodated in the substrate accommodating portion, by using power supplied from the battery pack accommodated in the battery accommodating portion; and

a control unit for controlling operation of the load,

wherein

the first opening is provided on a face of the housing in a first direction, and the second opening and the third opening are provided on a face of the housing in a second direction on the opposite side to the first direction.
(2)

The aerosol-generating system as disclosed in (1) above, further comprising a cover portion for opening/closing the second opening, and a cover portion for opening/closing the third opening.
(3)

The aerosol-generating system as disclosed in (2) above, further comprising a locking mechanism for locking the cover portion for opening/closing the second opening in a state of closing the second opening, wherein

the locking mechanism comprises a recess and a hook portion, locks the cover portion for opening/closing the second opening by means of insertion of the hook into the recess, and unlocks the cover portion for opening/closing the second opening by means of removal of the hook portion from the recess, and

the hook portion is provided on one of the housing and the cover portion for opening/closing the second opening, with the recess being provided on the other.
(4)

The aerosol-generating system as disclosed in (1) above, further comprising a cover portion for opening/closing the third opening, wherein

the cover portion for opening/closing the third opening opens/closes the third opening while also opening/closing the second opening.
(5)

The aerosol-generating system as disclosed in any one of (2) to (4) above, wherein the cover portion for opening/closing the third opening is provided to be detachable from the housing.
(6)

The aerosol-generating system as disclosed in any one of (2) to (5) above, further comprising a locking mechanism for locking the cover portion for opening/closing the third opening in a state of closing the third opening.
(7)

The aerosol-generating system as disclosed in (6) above, wherein the control unit controls operation of the locking mechanism for locking the cover portion for opening/closing the third opening, based on an operating state of the aerosol-generating system.
(8)

The aerosol-generating system as disclosed in (6) or (7) above, further comprising a cover portion for opening/closing the first opening, wherein

the control unit controls operation of the locking mechanism for locking the cover portion for opening/closing the third opening so that unlocking of the cover portion for opening/closing the third opening is prohibited in a state in which the cover portion for opening/closing the first opening has opened the first opening, and the second opening is in a closed state.
(9)

The aerosol-generating system as disclosed in any one of (2) to (8) above, further comprising an opening/closing sensor for detecting whether or not the cover portion for opening/closing the third opening has closed the third opening, wherein the control unit controls operation of the load based on a detection result from the opening/closing sensor.
(10)

The aerosol-generating system as disclosed in any one of (1) to (9) above, further comprising a liquid leak detector which is formed by a liquid-absorbent material arranged at a position in contact with the battery pack accommodated in the battery accommodating portion, and which undergoes a change in external appearance as a result of absorbing liquid.
(11)

The aerosol-generating system as disclosed in any one of (1) to (10) above, further comprising a charging terminal for receiving power for charging the battery pack, supplied from an external power source, wherein

the charging terminal is arranged on the first direction side of the battery accommodating portion, at a position offset from the load in a direction from the second opening toward the third opening.
(12)

The aerosol-generating system as disclosed in any one of (1) to (11) above, further comprising the substrate.

### REFERENCE SIGNS LIST

100 Inhalation device
102 Top face
103 Bottom face
111 Power source unit
112 Sensor unit
113 Notification unit
114 Memory unit
115 Communication unit
116 Control unit
121 Heating unit
140 Accommodating portion
140 Substrate accommodating portion
141 Internal space
142 Opening
143 Bottom portion
144 Heat insulating portion
150 Stick-type substrate
151 Substrate portion
152 Mouthpiece portion
160 Housing
161 Heater cover
162 Cleaning hole
162a Opening
162b Recess
163 Cleaning hole cover
163a Rotary shaft
163b Hook portion
163c Spring
164 Battery accommodating portion
164a Opening
165 Battery cover
165a Rotary shaft
165b Retainer 165b
166 Liquid leak detector
167 Bottom face cover
170 Battery pack
171 Electrode
180 Control circuit
181 Charging circuit
182 Charging terminal
183 Battery terminal
184 Opening/closing sensor

1-12. (canceled)

13. An aerosol-generating system comprising:
a housing;
a first chamber within the housing, the first chamber having a first opening and an internal space configured to receive and hold a substrate such that the substrate can be inserted and removed through the first opening;
a passage having openings at both ends, the passage having a second opening and being connected to the first chamber;
a second chamber within the housing, the second chamber having a third opening and an internal cavity configured to receive and hold a battery pack such that the battery pack can be inserted and removed through the third opening;
a heating element configured to heat an aerosol source contained in the substrate received in the first chamber using power supplied from the battery pack; and
circuitry configured to control operation of the heating element, wherein the first opening is provided on a face of the housing in a first direction, and the second opening and the third opening are provided on a face of the housing in a second direction opposite to the first direction.

14. The aerosol-generating system of claim 13, further comprising:
a first cover configured to open and close the second opening; and
a second cover configured to open and close the third opening.

15. The aerosol-generating system of claim 14, further comprising:
a locking mechanism configured to lock the first cover in a closed state relative to the second opening, wherein:
the locking mechanism comprises a recess and a hook portion;
the locking mechanism is configured to lock the first cover by insertion of the hook portion into the recess and to unlock the first cover by removal of the hook portion from the recess; and
the hook portion is provided on one of the housing and the first cover, with the recess being provided on the other.

16. The aerosol-generating system of claim 13, further comprising:
a cover configured to open and close the third opening, wherein
the cover is configured to open and close the third opening while simultaneously opening and closing the second opening.

17. The aerosol-generating system of claim 14, wherein
the second cover is detachably connected to the housing.

18. The aerosol-generating system of claim 14, further comprising:
a locking mechanism configured to lock the second cover in a closed state relative to the third opening.

19. The aerosol-generating system of claim 18, wherein
the circuitry is configured to control operation of the locking mechanism based on an operating state of the aerosol-generating system.

20. The aerosol-generating system of claim 18, further comprising:
a third cover configured to open and close the first opening, wherein
the circuitry is configured to control operation of the locking mechanism to prohibit unlocking of the second cover when the third cover has opened the first opening and the second opening is in a closed state.

21. The aerosol-generating system of claim 14, further comprising:
a sensor configured to detect whether the second cover has closed the third opening, wherein the circuitry is configured to control operation of the heating element based on a detection result from the sensor.

22. The aerosol-generating system of claim 13, further comprising:
a liquid-absorbent material arranged at a position in contact with the battery pack, the liquid absorbent material configured to undergo a change in external appearance as a result of absorbing liquid.

23. The aerosol-generating system of claim 13, further comprising:
a charging terminal configured to receive power for charging the battery pack from an external power source, wherein
the charging terminal is arranged on a side of the second chamber facing the first direction at a position offset from the heating element in a direction from the second opening toward the third opening.

24. The aerosol-generating system of claim 13, further comprising:
the substrate.

25. The aerosol-generating system of claim 13, wherein
the first chamber and the passage form a continuous through-hole extending from the first opening to the second opening.

26. The aerosol-generating system of claim 14, wherein
the first cover comprises a hinge configured to enable rotational opening and closing of the second opening.

27. The aerosol-generating system of claim 14, wherein
the second cover comprises a sliding mechanism.

28. The aerosol-generating system of claim 18, wherein
the locking mechanism comprises a retainer configured to slide laterally to lock and unlock the second cover.

29. The aerosol-generating system of claim 22, wherein
the liquid-absorbent material comprises at least one of paper, cloth, nonwoven fabric, a porous resin sheet, or a coated film.

30. The aerosol-generating system of claim 13, wherein
the heating element comprises a resistive heating element configured to generate heat through electrical resistance when supplied with power from the battery pack.

31. An aerosol-generating device comprising:
a housing;
a first chamber within the housing having a first opening configured to receive a substrate;
a passage connected to the first chamber and having a second opening;
a second chamber within the housing having a third opening configured to receive a battery pack;
a heating element configured to heat an aerosol source using power from the battery pack; and
circuitry configured to control the heating element, wherein the first opening is on a first face of the housing and the second and third openings are on an opposite face of the housing.

32. An aerosol-generating system comprising:
a housing having a top face and a bottom face;
a first chamber within the housing having a first opening on the top face and an internal space configured to receive and hold a substrate such that the substrate can be inserted and removed through the first opening;
a passage having openings at both ends, the passage having a second opening on the bottom face and being connected to the first chamber;
a second chamber within the housing having a third opening on the bottom face and an internal cavity configured to receive and hold a removable battery pack such that the battery pack can be inserted and removed through the third opening;
a resistive heating element configured to heat an aerosol source contained in the substrate using power supplied from the battery pack;
a first cover configured to open and close the first opening;
a second cover configured to open and close the second opening;
a third cover configured to open and close the third opening;
a sensor configured to detect whether the third cover is closed;
a charging terminal arranged on the housing; and
circuitry configured to control operation of the heating element based on operating states of the system and sensor detection, wherein
the first opening is provided on the top face in a first direction, and the second opening and third opening are provided on the bottom face in a second direction opposite to the first direction.
